(19) United States
(12) Patent Application Publication
(10) Pub. No.: US 2026/0316602 A1
(43) Pub. Date: Oct. 15, 2026

(54) Methods and Systems for In-Field Charging of Electric Vehicle Fleets

(71) Applicant: Harbinger Motors Inc., Garden Grove, CA (US)

(72) Inventors: John Henry Harris, III, Anaheim, CA (US); Phillip John Weicker, Hermosa Beach, CA (US)

(21) Appl. No.: 19/648,737

(22) Filed: Apr. 15, 2026

Related U.S. Application Data
(60) Provisional application No. 63/788,928, filed on Apr. 15, 2025.

(51) Int. Cl. B60L 53/10; B60L 50/64; B60L 53/30; B60L 53/302; B60L 53/31; B60L 53/36; B60L 53/53; B60L 53/66; B60L 53/67; B60L 53/68; B60L 58/12

(52) U.S. Cl. CPC B60L 53/11; B60L 50/64; B60L 53/302; B60L 53/305; B60L 53/31; B60L 53/36; B60L 53/53; B60L 53/66; B60L 53/67; B60L 53/68; B60L 58/12; B60L 2200/36; B60L 2210/10; B60L 2240/62; B60L 2240/72; B60L 2260/54

(57) ABSTRACT

Described herein are mobile charging EVs used for charging a similar vehicle type referred to as standard EVs. Each mobile charging EV is equipped with a DC-DC converter that facilitates direct current fast charging (DCFC) of standard vehicles, e.g., dynamically adjusting for voltage fluctuations caused by the state of charge (SOC) changes. In some examples, a mobile charging EV may also include an additional set of batteries to ensure energy storage/power capabilities needed for charging standard EVs. Furthermore, a standard EV may be reconfigured into a mobile charging EV, e.g., by adding a DC-DC converter and, in some examples, additional battery packs. The mobile charging and standard EVs may be frame-based vehicles that support and, in some examples, surround the battery packs (and DC-DC converters on mobile charging EVs). Also described are methods of managing fleets comprising mobile charging and standard EVs.

### CROSS-REFERENCE TO RELATED APPLICATIONS

This application claims the benefit under 35 U.S.C. § 119(e) of U.S. Provisional Patent Application 63/788,928, filed on 2025 Apr. 15, which is incorporated herein by reference in its entirety for all purposes.

### BACKGROUND

Electric vehicles (EVs) face range limitations due to battery capacity and charging infrastructure availability. While stationary charging stations are common, they lack flexibility in remote or high-demand areas. Mobile charging solutions, such as service trucks with direct current fast charging (DCFC) capabilities, can address this issue but often require special vehicles equipped with dedicated battery systems and/or generators, reducing efficiency and payload capacity.

Existing solutions typically separate propulsion and charging batteries, increasing the cost and complexity of mobile charging. A need exists for a configurable EV platform that integrates propulsion and high-power charging while maintaining modularity for different use cases.

### SUMMARY

Described herein are mobile charging EVs used for charging a similar vehicle type, referred to as standard EVs. However, each mobile charging EV is equipped with a DC-DC converter that facilitates direct current fast charging (DCFC) of standard vehicles, e.g., dynamically adjusting for voltage fluctuations caused by the state of charge (SOC) changes. In some examples, a mobile charging EV may also include an additional set of batteries to ensure energy storage/power capabilities needed for charging standard EVs. Furthermore, a standard EV may be reconfigured into a mobile charging EV, e.g., by adding a DC-DC converter and, in some examples, additional battery packs. The mobile charging and standard EVs may be frame-based vehicles that support and, in some examples, surround the battery packs (and DC-DC converters on mobile charging EVs). Also described are methods of managing fleets comprising mobile charging and standard EVs.

Clause 1. A mobile charging electric vehicle configured to charge a standard electric vehicle, the mobile charging electric vehicle comprising: a frame; a base set of battery packs supported on the frame; a DC-DC converter connected to the base set of battery packs and comprising a charging port for forming a direct current fast charging (DCFC) connection with the standard electric vehicle; a power electronic unit connected to at least the base set of battery packs; and an electric drive unit connected to the power electronic unit and configured to propel the mobile charging electric vehicle.

Clause 2. The mobile charging electric vehicle of clause 1, further comprising an additional set of battery packs supported on the frame, wherein the DC-DC converter is also connected to the additional set of battery packs.

Clause 3. The mobile charging electric vehicle of clause 2, wherein the additional set of battery packs comprises multiple battery packs.

Clause 4. The mobile charging electric vehicle of clause 2, wherein the power electronic unit is further connected to an additional set of battery packs.

Clause 5. The mobile charging electric vehicle of clause 2, wherein the base set of battery packs and the additional set of battery packs use the same type of battery packs.

Clause 6. The mobile charging electric vehicle of clause 2, wherein all battery packs in the base set of battery packs and the additional set of battery packs are connected to the DC-DC converter in parallel.

Clause 7. The mobile charging electric vehicle of clause 1, further comprising a liquid cooling system fluidically coupled to and configured to control the temperature of the base set of battery packs.

Clause 8. The mobile charging electric vehicle of clause 7, wherein the liquid cooling system is further fluidically coupled to and configured to control the temperature of the DC-DC converter, the power electronic unit, and the electric drive unit.

Clause 9. The mobile charging electric vehicle of clause 1, wherein the base set of battery packs comprises multiple battery packs.

Clause 10. The mobile charging electric vehicle of clause 1, wherein: the frame comprises side rails and cross-members, the side rails extend parallel to each other along the length of the mobile charging electric vehicle, the cross-members extend substantially perpendicular to the side rails, and at least one of the base set of battery packs is supported on the cross-members.

Clause 11. The mobile charging electric vehicle of clause 10, wherein at least one of the base set of battery packs is positioned between the side rails.

Clause 12. The mobile charging electric vehicle of clause 11, wherein all battery packs in the base set of battery packs are positioned between the side rails.

Clause 13. The mobile charging electric vehicle of clause 10, wherein at least one battery pack of the base set of battery packs is positioned above a plane defined by a top surface of the side rails.

Clause 14. The mobile charging electric vehicle of clause 10, wherein at least one battery pack of the base set of battery packs is positioned above a plane defined by the top surface of the side rails and proximate to the front of the frame.

Clause 15. The mobile charging electric vehicle of clause 10, wherein the DC-DC converter is positioned between the side rails.

Clause 16. The mobile charging electric vehicle of clause 1, wherein each battery pack in the base set of battery packs is removably mounted to the frame.

Clause 17. The mobile charging electric vehicle of clause 1, wherein the DC-DC converter is removably mounted to the frame, thereby allowing the reconfiguration of the mobile charging electric vehicle into the standard electric vehicle.

Clause 18. The mobile charging electric vehicle of clause 1, further comprising a cargo space positioned above and supported on the frame and configured to carry people and/or freight.

Clause 19. The mobile charging electric vehicle of clause 1, wherein each of the mobile charging electric vehicle and the standard electric vehicle is one of a box truck, a tow truck, a dump truck, a utility/service truck, a refrigerated truck, an ambulance/emergency vehicle, a recreation vehicle (RV), and a shuttle bus/passenger van.

Clause 20. The mobile charging electric vehicle of clause 1, wherein each of the mobile charging electric vehicle and the standard electric vehicle is one of a Class 2 truck, a Class 3 truck, a Class 4 truck, and a Class 5 truck.

Clause 21. The mobile charging electric vehicle of clause 1, wherein the mobile charging electric vehicle and the standard electric vehicle are substantially the same, except for the DC-DC converter.

Clause 22. The mobile charging electric vehicle of clause 1, wherein the DC-DC converter is configured to dynamically adjust output voltage based on battery voltage fluctuations of the base set of battery packs, as well as battery voltage of the standard electric vehicle during charging.

Clause 23. The mobile charging electric vehicle of clause 1, further comprising a charging vehicle controller configured to control the power output of the DC-DC converter and the remaining state of charge (SOC) of each of the base set of battery packs.

Clause 24. The mobile charging electric vehicle of clause 1, wherein the DC-DC converter is bidirectional for charging the mobile charging electric vehicle using another mobile charging electric vehicle.

Clause 25. The mobile charging electric vehicle of clause 1, wherein the charging port comprises one or more ports selected from the group of a combined charging system type 1 (CCS1) charger, a combined charging system type 2 (CCS2) charger, a charge de move (CHAdeMO) charger, a North American charging standard (NACS) charger, a Guobiao dc fast charging (GB/T DC) charger, and a megawatt charging system (MCS) charger.

Clause 26. The mobile charging electric vehicle of clause 1, wherein the charging port comprises a robotic arm for forming an electrical connection to the standard electric vehicle.

Clause 27. An electric vehicle configured to operate as a mobile charging electric vehicle and a standard electric vehicle, the electric vehicle comprises: a frame; a base set of battery packs supported on the frame; a power electronic unit connected to at least the base set of battery packs; and an electric drive unit connected to the power electronic unit and configured to propel the mobile charging electric vehicle, wherein the frame is further configured to support a DC-DC converter for connection to the base set of battery packs, when the electric vehicle is configured as the mobile charging electric vehicle, and comprising a charging port for forming a direct current fast charging (DCFC) connection with the standard electric vehicle.

Clause 28. A method of operating an EV fleet comprising a mobile charging EV sub-fleet and a standard EV sub-fleet, the method comprising: deploying the EV fleet in an operating area; receiving location and state of charge (SOC) from each mobile charging electric vehicle and each standard electric vehicle; receiving, at a control base, a charging request from one standard electric vehicle in the standard EV sub-fleet; selecting, at the control base, one mobile charging electric vehicle from the mobile charging EV sub-fleet; positioning the one mobile charging electric vehicle and the one standard electric vehicle next to each other; forming a direct current fast charging (DCFC) connection between the one mobile charging electric vehicle and the one standard electric vehicle next to each other; transmitting electrical energy from the one mobile charging electric vehicle to the one standard electric vehicle using the DCFC connection; disconnecting the one mobile charging electric vehicle from the one standard electric vehicle.

Clause 29. The method of clause 28, wherein the charging request is generated by one standard electric vehicle and transmitted to the control base.

Clause 30. The method of clause 28, wherein the charging request is generated at the control base based on the location and the SOC of a standard electric vehicle.

Clause 31. The method of clause 30, wherein the charging request is further generated based on a planned route for the standard electric vehicle.

Clause 32. The method of clause 28, wherein transmitting the electrical energy from one mobile charging electric vehicle to one standard electric vehicle further comprises circulating a cooling liquid through at least the DC-DC converter of the one mobile charging electric vehicle.

Clause 33. The method of clause 28, further comprising: establishing priority charging zones within the operating area based on historical demand patterns; and pre-positioning at least one mobile charging electric vehicle in each of the priority charging zones during high demand periods in the historical demand patterns.

Clause 34. The method of clause 33, wherein pre-positioning comprises calculating a combined reserve SOC level for each priority charging zone based on: (i) the number of standard electric vehicles in each of the priority charging zones, and (ii) a remaining energy demand for each of the standard electric vehicles based on a planned route.

Clause 35. The method of clause 28 further comprising prioritizing the charging request based on the location and the SOC of the standard electric vehicle associated with the charging request.

Clause 36. The method of clause 28, further comprising calculating real-time energy budgets for sub-regions of the operating area based on: (i) current SOC distribution across all vehicles, and (ii) predicted energy consumption for active service routes.

Clause 37. The method of clause 28, further comprising reconfiguring the EV fleet by transferring one or more electric vehicles between the mobile charging EV sub-fleet and the standard EV sub-fleet.

Clause 38. The method of clause 28, further comprising reconfiguring the EV fleet by changing the number of battery packs on one or more electric vehicles of the mobile charging EV sub-fleet and/or the standard EV sub-fleet.

These and other embodiments are described further below with reference to the figures.

### BRIEF DESCRIPTION OF THE DRAWINGS

FIG. 1A is a schematic side view of an EV, which may be configured as either a mobile charging EV or a standard EV, in accordance with some examples.

FIG. 1B is a schematic view of the frame and battery packs of the EV in FIG. 1A, in accordance with some examples.

FIG. 1C is a schematic view of the cooling system of the EV in FIG. 1A, in accordance with some examples.

FIG. 2A is a block diagram of a mobile charging EV and a standard EV forming a DCFC connection, in accordance with some examples.

FIG. 2B illustrates a block diagram of a fleet comprising one or more mobile charging EVs and one or more standard EVs in an operating area, in accordance with some examples.

FIG. 3 is a process flowchart of operating an EV fleet comprising a mobile charging EV sub-fleet and a standard EV sub-fleet, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### Examples of Mobile Charging and Standard EVs

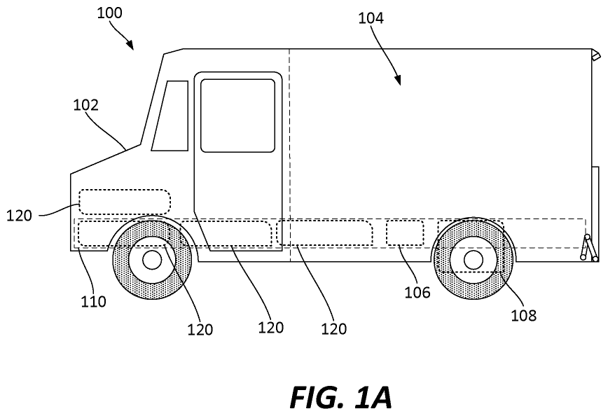

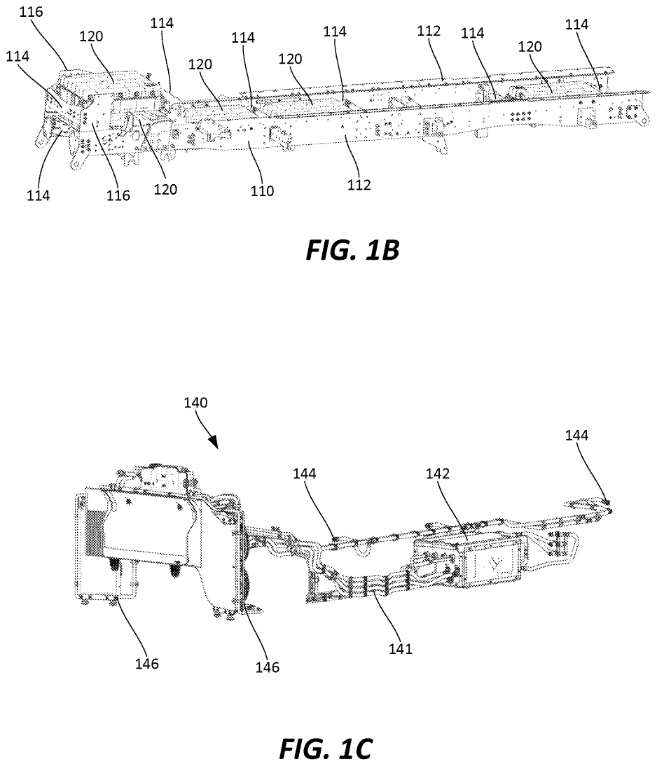

FIG. 1A illustrates an electric vehicle 100, which may be used as a mobile charging electric vehicle 192 or as a standard electric vehicle 194 depending on its configuration (e.g., the presence of the DC-DC converter 130 and, in some examples, the number of battery packs positioned on the electric vehicle 100). In either configuration, the electric vehicle 100 comprises a frame 110 and a set of battery packs 120 of battery packs 121 supported on the frame 110. The electric vehicle 100 also comprises a body 102 and a cargo space 104. The cargo space 104 may be positioned above and supported on the frame 110 and configured to carry people and/or freight. The electric vehicle 100 may also comprise a power electronic unit 106 and an electric drive unit 108.

FIG. 1B is a schematic view of a frame 110 and a set of battery packs 120 of the electric vehicle 100 in FIG. 1A, in accordance with some examples. The frame 110 comprises two side rails 112 and multiple cross-members 114, extending between the side rails 112 and supporting the side rails 112 relative to each other. The frame 110 may also comprise side rail extensions 116 that are attached to and supported by the side rails 112. The side rail extensions 116 extend above the plane defined by the top surface of the side rails 112 and allow positioning of one or more battery packs 120 above the side rails 112.

FIG. 1B illustrates an example with five battery packs 120, such that four battery packs 120 are positioned between the side rails 112, while the remaining one battery pack 120 is positioned between the side rail extensions 116 (and above the side rails 112). This remaining battery pack 120 is stacked with another battery pack 120 (that is positioned between the side rails 112) at the front of the electric vehicle 100 thereby helping with the overall weight distribution (e.g., when the cargo space 104 is loaded). The side rails 112 or the side rail extensions 116 protect the battery packs 120 from being damaged. At the same time, the battery packs 120 may be supported using the cross-members 114, which allows at least some of the battery packs 120 to be removed (e.g., for servicing, replacement, or addition) from the bottom of the electric vehicle 100. The front two battery packs 120 may require the removal of the cross-members 114 to remove these battery packs 120 from the electric vehicle 100.

These battery packs 120 may form a base set of battery packs 121 and, in some examples, an additional set of battery packs 122. For example, a standard electric vehicle 194 may have fewer battery packs (e.g., only a base set of battery packs 121) than a mobile charging electric vehicle 192 (e.g., which also has an additional set of battery packs 122). Alternatively, both the standard electric vehicle 194 and the mobile charging electric vehicle 192 have the same number of battery packs, e.g., a single battery pack. When the same number of battery packs are used, these battery packs may be similar (e.g., have the same energy capacity) or different (e.g., have different energy capacities).

Additional battery packs may be used by the mobile charging electric vehicle 192 to provide sufficient energy and power during the charging of other electric vehicles, as well as to propel the mobile charging electric vehicle 192 (itself). Overall, in some examples, the overall energy storage capacity of the mobile charging electric vehicle 192 may be greater than that of the standard electric vehicle 194, e.g., by at least 25%, at least 50%, or even at least 100%. In more specific examples, the standard operating voltage of the mobile charging electric vehicle 192 and standard electric vehicle 194 may be the same (e.g., all battery packs interconnected in parallel). For example, the base set of battery packs 121 may be allocated to propulsion and vehicle auxiliaries, while the additional set of battery packs 122 may be allocated to off-board charging, although either set may be used for either function depending on operating conditions.

For example, each battery pack may have a nominal energy capacity of 20-50 kWh, such as 30-40 kWh, or about 35 kWh. The nominal voltage range may be 480-805V with a usable voltage range of 518-800V. The battery pack may support fast charging operations, enabling state-of-charge (SOC) increases from 20% to 90% within approximately one hour under appropriate conditions. This fast-charging capability is facilitated by a liquid cooling system (e.g., using a mixture of water and ethylene glycol). Specifically, each battery pack may have a set of modules with individual flow paths and a high-pressure die-cast (HPDC) monolithic cold plate (e.g., positioned between two sets of cells). This liquid cooling may be capable of rejecting at least 1 kW, at least 2 kW, or even at least 2.5 kW of heat (from each battery pack) during its operation. For example, coolant flow rates of at least 2 L/min, 4 L/min, or even 6 L/min may be used.

The battery packs 120 are configured for integration into medium-duty electric vehicles or, more specifically, for attaching to the frame and positioned between the two frame rails. For example, the length of each battery pack may be 600-1200 millimeters or, more specifically, 800-1000 millimeters, such as 900-950 millimeters. The width of each battery pack may be 500-900 millimeters or, more specifically, 600-800 millimeters, such as 650-750 millimeters. The height of each battery pack may be 150-350 millimeters or, more specifically, 200-300 millimeters, such as 240-280 millimeters. The gravimetric energy density may be 150-190 Wh/kg, such as about 170 Wh/kg, while the volumetric energy density may be 200-230 Wh/L, such as about 215 Wh/L. The modular architecture allows for multiple packs to be installed in parallel, thereby supporting a wide range of total system capacities while preserving design uniformity and ease of maintenance.

FIG. 1C is a schematic view of a cooling system 140 of the electric vehicle 100 in FIG. 1A, in accordance with some examples. The liquid cooling system 140 comprises a set of cooling lines 141 interconnecting battery pack connectors 144, one or more radiators 146, and (optionally) other components. For example, the liquid cooling system 140 may also comprise a thermal box 142 that controls the flow among various components of the liquid cooling system 140. Each battery pack connector 144 is configured to connect to one of the battery packs 120 such that a liquid coolant can circulate through the connected battery packs 120. It should be noted that some of the battery pack connectors 144 may not be connected to battery packs 120 (and remain available for further battery pack expansion).

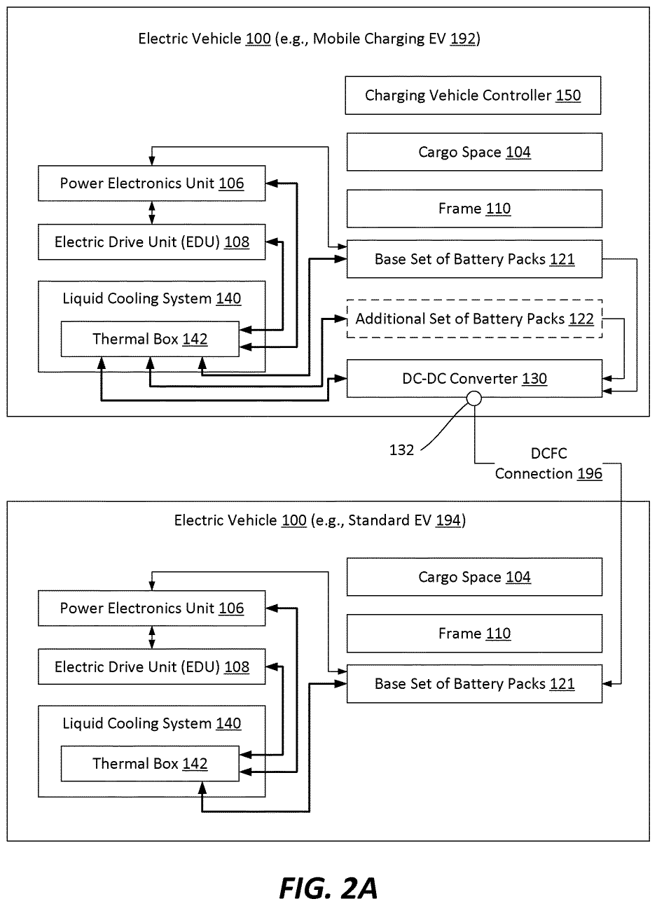

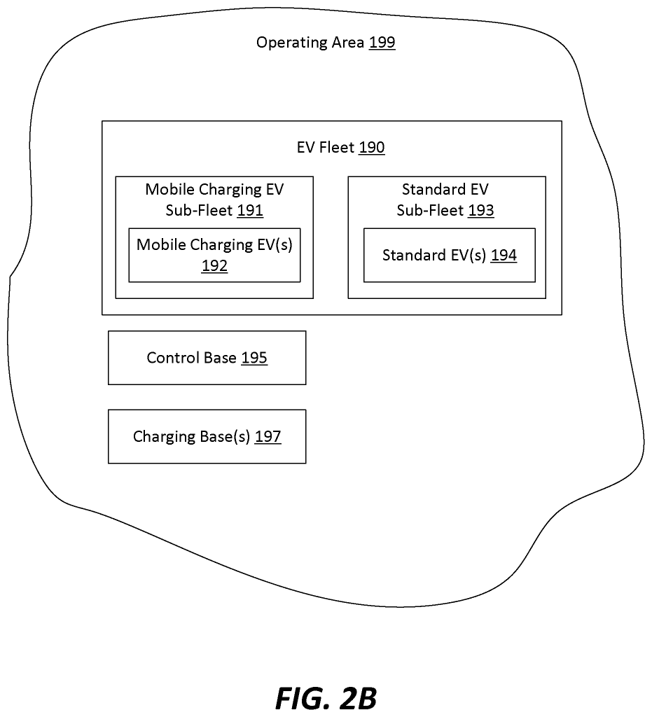

FIG. 2A is a block diagram of a mobile charging electric vehicle 192 and a standard electric vehicle 194 forming a DCFC connection 196, in accordance with some examples. As noted above, both types of electric vehicles 100 (i.e., the mobile charging electric vehicle 192 and the standard electric vehicle 194) comprise a cargo space 104, frame 110, power electronic unit 106, electric drive unit 108, liquid cooling system 140, and a base set of battery packs 121. However, unlike a standard electric vehicle 194, the mobile charging electric vehicle 192 also comprises a DC-DC converter 130. In some examples, the mobile charging electric vehicle 192 and the standard electric vehicle 194 are substantially the same, except for the DC-DC converter 130 and the additional set of battery packs 122. The DC-DC converter 130 is configured to dynamically adjust output voltage based on battery voltage fluctuations of the base set of battery packs 121 and the additional set of battery packs 122, as well as the battery voltage of the standard electric vehicle 194 during charging.

In some examples, the mobile charging electric vehicle 192 further comprises a charging vehicle controller 150 configured to control the power output of the DC-DC converter 130 and a remaining state of charge (SOC) of each of the base set of battery packs 121 and the additional set of battery packs 122.

A DC-DC converter 130 may be used to accommodate (1) the dynamic voltage changes in both the source and destination battery packs as their states of charge (SOC) vary and/or (2) to address different voltage systems used on the mobile charging electric vehicle 192 and standard electric vehicle 194 (e.g., using different number of battery packs 120 interconnected in series). The dynamic voltage changes are attributed to voltage dropping at low charge and rising toward full charge. For example, a 400V battery pack may operate between 300V (at a low SOC) and 450V (at a high SOC). It should be noted that these variations occur both in (2) the battery packs that are used for charging, with the voltage dropping as these battery packs are being discharged, and (b) the battery packs that are being charged, with the voltage increasing as these battery packs are being charged. These voltage ranges depend on the cell chemistry, selected cutoff voltages (that are used to control the battery degradation), and the number of battery cells interconnected in series. A DC-DC converter 130 is used to address these variations to dynamically control and maintain efficient power transfer.

It should be noted that the relationship between voltage and SOC is nonlinear, meaning the duty cycle or phase-shift modulation (in some examples, such as a dual-active bridge converter) in a DC-DC converter 130 may need to be continuously adjusted to match the instantaneous voltages. For example, a real-time feedback control may be used, e.g., managed by a charging vehicle controller 150.

When the battery pack voltage on the mobile charging electric vehicle 192 is lower than the battery pack voltage on the standard electric vehicle 194, the DC-DC converter 130 operates in a boost mode. Conversely, the DC-DC converter 130 may operate in a buck mode. Advanced topologies like bidirectional buck-boost or resonant converters mitigate these issues by smoothly transitioning across voltage ranges while maintaining soft-switching to reduce losses.

In some examples, the DC-DC converter 130 and/or the charging vehicle controller 150 are configured to control one or more charging parameters during a charging event, such as output voltage, output current, output power, ramp rate, duty cycle, phase shift, charge duration, and charging termination criteria. For example, charging may begin at a first power level, continue under constant-current and/or constant-power control, and taper under constant-voltage control as a target state of charge of the standard electric vehicle 194 is approached. Charging may be terminated based on any one or more of: a requested energy amount being delivered, the standard electric vehicle 194 reaching a target SOC, the mobile charging electric vehicle 192 reaching a minimum reserve SOC, a connector temperature threshold, a battery temperature threshold, a current threshold, a time threshold, or a fault condition.

Overall, referring to FIG. 2A, a mobile charging electric vehicle 192 is configured to charge a standard electric vehicle 194 and comprises a frame 110, a base set of battery packs 121 supported on the frame 110, (optionally) an additional set of battery packs 122 supported on the frame 110, and a DC-DC converter 130 connected to both the base set of battery packs 121 and the additional set of battery packs 122 and comprising a charging port 132 for forming a direct current fast charging (DCFC) connection with the standard electric vehicle 194. The mobile charging electric vehicle 192 also comprises a power electronic unit 106 connected to at least the base set of battery packs 121 and an electric drive unit 108 connected to the power electronic unit 106 and configured to propel the mobile charging electric vehicle 192.

In some examples, the DC-DC converter 130 is bidirectional for charging the mobile charging electric vehicle 192 using another mobile charging electric vehicle 192. The charging port 132 comprises one or more ports selected from the group of a combined charging system type 1 (CCS1) charger, a combined charging system type 2 (CCS2) charger, a charge de move (CHAdeMO) charger, a North American charging standard (NACS) charger, a Guobiao dc fast charging (GB/T DC) charger, and a megawatt charging system (MCS) charger. In some examples, the charging port 132 comprises a robotic arm for forming an electrical connection to the standard electric vehicle 194.

In some examples, the charging port 132, the DC-DC converter 130, and/or the charging vehicle controller 150 implement one or more safety features before and during formation of the DCFC connection 196. Such features may include connector presence detection, communication handshaking with the standard electric vehicle 194, insulation monitoring, ground-fault detection, pre-charge of input and/or output capacitors, contactor sequencing, arc mitigation, overcurrent protection, overvoltage protection, undervoltage protection, overtemperature protection, coolant-flow verification, and/or emergency shutoff. Upon detection of a fault condition, the charging vehicle controller 150 may reduce power, open one or more contactors, isolate one or more battery packs 120, and/or terminate the charging event.

In some examples, the mobile charging electric vehicle further comprises a liquid cooling system 140 fluidically coupled to and configured to control the temperature of each of the base set of battery packs 121 and the additional set of battery packs 122. For example, the liquid cooling system 140 may be further fluidically coupled to and configured to control the temperature of the DC-DC converter 130, the power electronic unit 106, and the electric drive unit 108.

In some examples, the base set of battery packs 121 comprises multiple battery packs, e.g., 2, 3, 4, or 5 battery packs. In the same or other examples, the additional set of battery packs 122 comprises multiple battery packs, e.g., 2, 3, 4, or 5 battery packs.

As noted above, frame 110 comprises side rails 112 and cross-members 114. The side rails 112 extend parallel to each other along the length of the mobile charging electric vehicle 192. The cross-members 114 extend substantially perpendicular to the side rails 112. At least one battery pack of the base set of battery packs 121 and the additional set of battery packs 122 is supported on the cross-members 114. In some examples, at least one battery pack of the base set of battery packs 121 and the additional set of battery packs 122 is positioned between the side rails 112. In more specific examples, all battery packs in the base set of battery packs 121 and the additional set of battery packs 122 are positioned between the side rails 112. Alternatively, at least one battery pack of the base set of battery packs 121 and the additional set of battery packs 122 is positioned above a plane defined by the top surface of the side rails 112. For example, at least one battery pack of the base set of battery packs 121 and the additional set of battery packs 122 is positioned above a plane defined by a top surface of the side rails 112 and proximate to the front of the frame 110.

In some examples, the base set of battery packs 121 and the additional set of battery packs 122 use the same type of battery packs. In other words, battery packs in the base set of battery packs 121 and the additional set of battery packs 122 are interchangeable. Each battery pack in the base set of battery packs 121, and the additional set of battery packs 122, may be removably mounted to the frame 110.

In some examples, all battery packs in the base set of battery packs 121 and the additional set of battery packs 122 are connected to the DC-DC converter 130 in parallel. As such, the nominal operating voltage of the mobile charging electric vehicle 192 does not depend on the number of battery packs (in either set).

In some examples, each battery pack 120 is coupled to the DC-DC converter 130 through a respective switching device, contactor set, fuse, or other isolation device such that battery packs 120 may be selectively connected, disconnected, or bypassed. As such, all battery packs need not be connected to the DC-DC converter 130 at all times. For example, one subset of battery packs 120 may be used for propulsion while another subset is used for charging, one or more battery packs 120 may be taken offline in response to a fault or service condition, or different subsets of battery packs 120 may be sequentially used during a charging event to manage thermal load, power delivery, aging, and/or reserve energy.

In some examples, the DC-DC converter 130 is positioned between the side rails 112, e.g., similar to one of the battery packs 120. Alternatively, the DC-DC converter 130 is positioned at another location, e.g., in cargo space 104. The DC-DC converter 130 is removably mounted to the frame 110, thereby allowing reconfiguration of the mobile charging electric vehicle 192 into the standard electric vehicle 194. For example, a DC-DC converter 130 may be added to a standard electric vehicle 194 to convert this vehicle into a mobile charging electric vehicle 192. Alternatively, the DC-DC converter 130 may be removed from a mobile charging electric vehicle 192 to convert this vehicle into a standard electric vehicle 194. As further described below, the size and operation aspects of an EV fleet 190 may determine the side of the mobile charging EV sub-fleet 191.

In some examples, the charging port 132 and/or the DC-DC converter 130 are further configured to deliver electrical power to a non-vehicle load, such as stationary charging equipment, a building load, an emergency power panel, a mobile worksite, refrigeration equipment, or a microgrid interface. Accordingly, the mobile charging electric vehicle 192 may operate as a transportable energy source in addition to charging the standard electric vehicle 194.

In some examples, each of the mobile charging electric vehicle 192 and the standard electric vehicle 194 is one of a box truck, a tow truck, a dump truck, a utility/service truck, a refrigerated truck, an ambulance/emergency vehicle, a recreation vehicle (RV), or a shuttle bus/passenger van. In some examples, all vehicles in the EV fleet 190 are of the same type (e.g., all are box trucks). Alternatively, a mobile charging electric vehicle 192 may be a different type of vehicle from a standard electric vehicle 194. In some examples, each of the mobile charging electric vehicle 192 and the standard electric vehicle 194 is one of a Class 2truck, a Class 3 truck, a Class 4 truck, or a Class 5 truck.

### Examples of Reconfigurable Electric Vehicles

As noted above, an electric vehicle 100 is configured to operate as a mobile charging electric vehicle 192 and a standard electric vehicle 194. The electric vehicle 100 comprises a frame 110, a base set of battery packs 121 supported on the frame 110, a power electronic unit 106 connected to at least the base set of battery packs 121, and an electric drive unit 108 connected to the power electronic unit 106 and configured to propel the mobile charging electric vehicle 192.

The frame is configured to support an additional set of battery packs 122, different from the base set of battery packs 121, when the electric vehicle 100 is configured as the mobile charging electric vehicle 192. The frame is further configured to support a DC-DC converter 130 for connection to both the base set of battery packs 121 and the additional set of battery packs 122 when the electric vehicle 100 is configured as the mobile charging electric vehicle 192, and comprising a charging port 132 for forming a direct current fast charging (DCFC) connection with the standard electric vehicle 194.

Reconfiguring the electric vehicle 100 between the standard electric vehicle 194 configuration and the mobile charging electric vehicle 192 configuration may comprise mechanically mounting or removing the DC-DC converter 130, electrically coupling or decoupling the DC-DC converter 130 from the battery packs 120 through one or more high-voltage connectors or busbars, coupling or decoupling one or more coolant lines of the liquid cooling system 140, installing or removing one or more additional battery packs 122, updating controller software or calibration data associated with the charging vehicle controller 150, and verifying system readiness through a commissioning or diagnostic routine. In some examples, the frame 110 includes pre-positioned mounting features, electrical interfaces, and coolant interfaces to facilitate such conversion.

### Examples of Electric Vehicle Fleet

FIG. 2B illustrates a block diagram of an EV fleet 190 comprising one or more mobile charging electric vehicles 192 and one or more standard electric vehicles 194 in an operating area 199, in accordance with some examples. Specifically, one or more mobile charging electric vehicles 192 form a mobile charging EV sub-fleet 191, while one or more standard electric vehicles 194 form a standard EV sub-fleet 193. In some examples, the mobile charging EV sub-fleet 191 and the standard EV sub-fleet 193 operate within the same operating area 199 and are assigned to perform related or coordinated tasks, such as deliveries, service calls, pickups, passenger transport, return-to-base operations, or other route-based assignments. In some examples, the vehicles in the two sub-fleets are substantially the same type of vehicle, such that one or more vehicles may be reassigned or reconfigured between the two sub-fleets depending on fleet needs.

In some examples, the EV fleet 190 comprises or has access to a control base 195 and one or more charging bases 197. The control base 195 may be used for directing, monitoring, and coordinating the operation of the vehicles in the EV fleet 190. For example, the control base 195 may receive operating information from the vehicles, such as current location, current state of charge (SOC), route status, assigned task status, expected energy consumption, and availability for charging or dispatch. In some examples, the control base 195 determines how the mobile charging EV sub-fleet 191 and the standard EV sub-fleet 193 are to be deployed within the operating area 199 based on the operating requirements of each vehicle, such as a planned route, a remaining route segment, a predicted energy demand, and/or the current position of that vehicle relative to other vehicles or infrastructure within the operating area 199.

In further examples, the charging bases 197 provide stationary charging support for one or more vehicles in the EV fleet 190, while the mobile charging EV sub-fleet 191 provides in-field charging support for one or more vehicles in the standard EV sub-fleet 193. The goal may be to minimize the total time and/or distance spent by the EV fleet 190 in completing planned routes and other assignments. For example, the control base 195 may reduce the number of trips by standard electric vehicles 194 to the charging bases 197 by dispatching one or more mobile charging electric vehicles 192 to provide electrical energy within the operating area 199. In some examples, this coordinated use of charging bases 197 and the mobile charging EV sub-fleet 191 improves route completion, reduces service delays, preserves reserve energy within the fleet, and increases utilization of vehicles assigned to productive fleet operations

### Examples of Operating EV Fleets

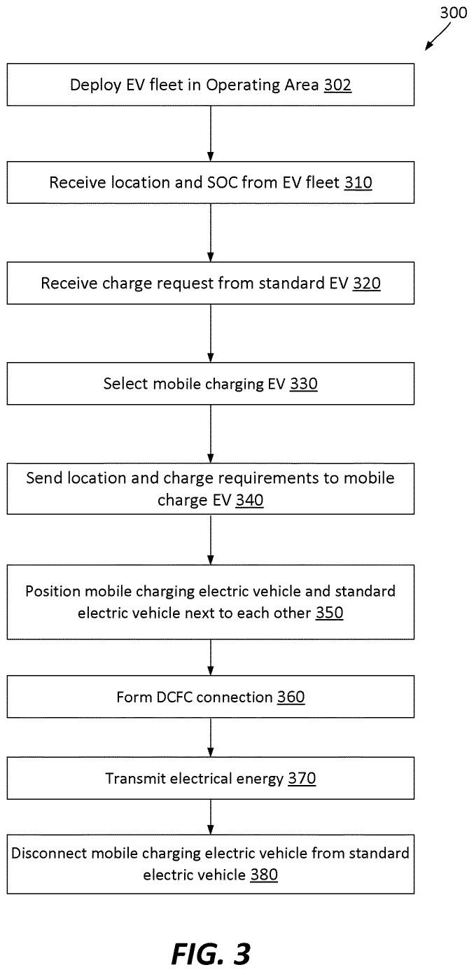

FIG. 3 is a process flowchart corresponding to method 300 of operating an EV fleet 190 comprising a mobile charging EV sub-fleet 191 and a standard EV sub-fleet 193, in accordance with some examples. Method 300 may comprise (block 302) deploying the EV fleet 190 in an operating area 199 and (block 310) receiving the location and state of charge (SOC) from each mobile charging electric vehicle 192 and each standard electric vehicle 194. The operating information may comprise one or more of location, state of charge (SOC), battery temperature, estimated remaining range, route status, assigned task status, estimated energy consumption, connector compatibility, fault status, traffic-related delay information, payload-related information, or ambient-condition information. In some examples, this receiving operation is performed periodically, intermittently, continuously, on demand, and/or in response to an event, such as an SOC threshold crossing, route deviation, fault event, traffic event, or charging completion event. The operating information may be communicated over one or more wireless networks within the operating area 199, such as between each vehicle and a control base 195, between vehicles, through one or more intermediary dispatch systems, through a cloud-based fleet-management platform, and/or through one or more telematics systems.

In some examples, the operating information received from each vehicle is associated with a timestamp, a confidence level, and/or a freshness/recentness indicator. For example, the control base 195 may determine whether recently received operating information is sufficiently current for use in dispatch decisions and may discount, interpolate, extrapolate, or otherwise estimate missing or stale operating information. For example, when one or more items of operating information are unavailable, delayed, or inconsistent, the control base 195 may continue operating method 300 using previously received operating information, route history, expected vehicle behavior, and/or one or more default reserve-energy rules until updated operating information is received.

In some examples, method 300 is operated when one or more communication links between the control base 195 and one or more vehicles in the EV fleet 190 are unavailable, delayed, or intermittent. For example, a standard electric vehicle 194 and/or a mobile charging electric vehicle 192 may continue operating based on previously received instructions, locally stored route information, locally determined charging-need criteria, fallback rendezvous rules, or one or more default reserve-SOC policies. In some examples, once communications are restored, updated operating information, charging-request information, and charging-event status information are synchronized with the control base 195.

In some examples, method 300 proceeds with (block 320) receiving, at a control base 195, a charging request (e.g., corresponding to the charging need associated with one standard electric vehicle 194 in the standard EV sub-fleet 193). For example, the charging need is identified when the SOC of the standard electric vehicle 194 drops below a threshold. In more specific examples, the threshold is dynamically determined based on one or more of: the current location of the vehicle relative to one or more charging bases 197, the current location of one or more mobile charging electric vehicles 192, a remaining route distance, a remaining route duration, expected energy consumption for a remaining route portion, traffic conditions, terrain, payload, weather, battery temperature, estimated charging wait time at a charging base 197, reserve SOC requirements, service-level commitments, or predicted charging demand within one or more portions of the operating area 199. The charging request may correspond to a predicted inability of the standard electric vehicle 194 to complete a current assignment, reach a charging base 197, satisfy a reserve-energy policy, or satisfy a dispatch constraint without receiving electrical energy from the mobile charging EV sub-fleet 191.

In some examples, the charging request is generated by the one standard electric vehicle 194 and transmitted to the control base 195. For example, the standard electric vehicle 194 may determine that external charging support is needed based on one or more locally determined conditions, such as SOC, predicted energy consumption, route completion likelihood, battery temperature, and/or distance to an available charging resource. Alternatively, the charging request may be generated at the control base 195 based on the location and the SOC of the one standard electric vehicle 194. In some examples, the charging request is generated by a fleet-management system, a dispatch platform, a cloud-based control system, a remote operator interface, or another vehicle, such as a mobile charging electric vehicle 192 assigned to monitor or assist one or more standard electric vehicles 194. In some examples, the charging request is automatically generated without driver input. In other examples, the charging request is generated in response to driver confirmation, dispatcher confirmation, or a mixed human-machine workflow.

In some examples, the charging request is further generated based on a planned route for the standard electric vehicle 194. For example, the planned route may comprise one or more delivery stops, service calls, pickup locations, return-to-base requirements, scheduled breaks, depot visits, and/or route segments associated with expected energy consumption. In some examples, the charging request is generated based on a comparison between available energy and predicted energy demand for at least a remaining portion of the planned route. The predicted energy demand may account for one or more of route length, travel time, average or expected speed, stop frequency, elevation change, traffic, weather, payload, auxiliary loads, and expected idling or dwell periods. In some examples, the charging request is generated when the standard electric vehicle 194 is predicted to be unable to complete a selected route segment, satisfy a reserve-energy target, maintain a service-level commitment, or reach a charging base 197 with at least a threshold remaining SOC. In some examples, the charging request is generated based on a route priority, a customer priority, a delivery deadline, a service window, and/or a fleet-level optimization objective.

In some examples, identifying the charging need associated with the standard electric vehicle 194 comprises calculating a charging-need score based on one or more weighted inputs. Such inputs may include the current SOC, predicted route energy demand, remaining distance to a charging base 197, estimated delay associated with traveling to the charging base 197, battery temperature, delivery or service priority, traffic conditions, and reserve-energy requirements. In further examples, a charging request is generated when the charging-need score exceeds a threshold, when the charging-need score is greater than corresponding scores of other vehicles competing for limited mobile charging resources, and/or when the charging-need score indicates that intervention by the mobile charging EV sub-fleet 191 is preferred over travel to stationary charging infrastructure.

In some examples, a charging request may be canceled, withdrawn, suppressed, or deferred before a charging event begins. For example, cancellation may occur when the standard electric vehicle 194 reaches a charging base 197, receives sufficient regenerative energy, is reassigned to a shorter route, experiences a reduction in projected energy demand, or is otherwise determined to no longer require mobile charging support. In further examples, the control base 195 updates charger reservations and priority rankings in response to cancellation or deferral of the charging request.

In some examples, method 300 proceeds with (block 330) selecting, at the control base 195, one mobile charging electric vehicle 192 from the mobile charging EV sub-fleet 191. For example, this selection operation may be accomplished based on one or more characteristics of candidate mobile charging electric vehicles 192, such as current location, state of charge (SOC), available energy, predicted arrival time, expected charging capability, current route commitment, compatibility with the requesting standard electric vehicle 194, thermal state, maintenance status, or expected ability to satisfy a reserve-energy requirement after completion of the charging event. In some examples, the selected mobile charging electric vehicle 192 is the closest candidate vehicle, the most highly charged candidate vehicle, the candidate vehicle having the lowest projected response cost, or the candidate vehicle having the greatest projected fleet-level benefit.

In some examples, selecting the one mobile charging electric vehicle 192 from the mobile charging EV sub-fleet 191 comprises optimizing across multiple variables, including distance to the requesting standard electric vehicle 194, predicted travel time, current SOC of candidate mobile charging electric vehicles 192, reserve SOC constraints for the operating area 199, predicted charging demand in nearby zones, route commitments of candidate vehicles, traffic conditions, charger compatibility, expected energy transfer amount, expected return-to-base energy margin, projected post-charge usefulness of a candidate vehicle, and/or a predicted effect on one or more fleet-performance metrics. The selection may be performed using a rule-based algorithm, a weighted score, a linear or nonlinear optimization, a heuristic search, a constraint-based search, a distributed decision process, and/or a machine-learning model trained on historical fleet operations. In some examples, the selection is updated in real time as new telemetry is received from the EV fleet 190.

In further examples, selecting the one mobile charging electric vehicle 192 is not final upon initial assignment. Rather, the control base 195 may re-evaluate the assignment while the selected mobile charging electric vehicle 192 is traveling toward the charging location and may maintain, modify, or cancel the assignment based on newly received operating information. For example, a different mobile charging electric vehicle 192 may be substituted when traffic changes, when another candidate becomes available, when reserve-energy constraints change, when the standard electric vehicle 194 changes location or route status, or when multiple charging requests compete for the same mobile charging resource.

In some examples, once a mobile charging electric vehicle 192 is selected for a charging event, the control base 195 reserves that mobile charging electric vehicle 192 for the charging event and temporarily excludes the selected mobile charging electric vehicle 192 from consideration for one or more other charging requests. The reservation may persist until the charging event is completed, canceled, reassigned, or timed out. In some examples, the control base 195 may also reserve a projected amount of energy, a charging time window, and/or a rendezvous location for the charging event.

In some examples, method 300 proceeds with (block 340) sending a charging location to the selected mobile charging electric vehicle 192 (and, optionally, to the standard electric vehicle 194 that transmitted the charging request). For example, the charging location may be selected to satisfy one or more proximity, safety, accessibility, traffic-flow, grade, connector reach, and cable-routing constraints. In some examples, the charging location is predetermined, dynamically computed, selected from a list of candidate rendezvous sites, or adjusted in real time based on changing traffic or vehicle position. Overall, method 300 may proceed with (block 350) positioning the one mobile charging electric vehicle 192 and the one standard electric vehicle 194 next to each other, (block 360) forming a direct current fast charging (DCFC) connection between the one mobile charging electric vehicle 192 and the one standard electric vehicle 194, and (block 370) transmitting electrical energy from the one mobile charging electric vehicle 192 to the one standard electric vehicle 194 using the DCFC connection. In some examples, the positioning operation is manual, semi-automated, or automated.

In some examples, after the charging location is sent, the control base 195 monitors the progress of the selected mobile charging electric vehicle 192 and the standard electric vehicle 194 toward the charging location. If one vehicle is expected to arrive materially earlier than the other, the control base 195 may direct the earlier-arriving vehicle to wait at the charging location, proceed to an alternate waiting position, or redirect to a revised charging location. In some examples, if the rendezvous fails to occur within a threshold time period, the charging request may be escalated, reprioritized, reassigned, or canceled.

In some examples, forming the DCFC connection comprises aligning the mobile charging electric vehicle 192 and the standard electric vehicle 194, verifying connector compatibility, establishing communication between the charging port 132 and a charging interface of the standard electric vehicle 194, confirming one or more safety conditions, and then enabling power transfer. For example, the communication exchanged during connection establishment may comprise one or more of the requested voltage, requested current, permissible power level, target SOC, fault information, battery temperature information, connector lock confirmation, and estimated charging duration.

In some examples, if the DCFC connection cannot be successfully formed, is interrupted after formation, or is terminated before transfer of a desired amount of energy, the control base 195 may initiate one or more remedial actions. For example, the remedial actions may include retrying connection establishment, selecting an alternate charging location, dispatching a different mobile charging electric vehicle 192, modifying a target energy amount, redirecting the standard electric vehicle 194 to a charging base 197, or updating route assignments to reduce energy demand on the standard electric vehicle 194.

In some examples, the charging event comprises multiple control phases, and the temperature of one or more battery packs 120 on the mobile charging electric vehicle 192 is monitored and controlled during each of the phases. For example, a first phase may comprise a ramp-up phase in which charging power is increased from an initial level toward a target charging level, a second phase may comprise a sustained charging phase under constant-current control, constant-power control, or a combination thereof, and a third phase may comprise a taper phase in which charging power is reduced as one or more charging limits are approached. In some examples, the control base 195 and/or the charging vehicle controller 150 receive temperature information associated with one or more battery packs 120 and determine a permitted current level, power level, and/or phase duration based at least in part on the temperature of the one or more battery packs 120.

In some examples, the temperature of one or more battery packs 120 is controlled to maintain the battery packs 120 within a target temperature range that is suitable for a current charging rate or discharging rate. For example, when the battery packs 120 are below a target temperature range, the charging vehicle controller 150 may limit current, delay transition to a higher-power phase, circulate coolant at a reduced rate, reduce heat rejection through one or more radiators 146, and/or otherwise allow the battery packs 120 to warm toward the target temperature range before increasing charging power. Conversely, when the battery packs 120 are at or above the target temperature range, the charging vehicle controller 150 may increase coolant flow, increase heat rejection, reduce charging current, shorten a constant-current phase, begin tapering earlier, and/or selectively reduce power drawn from one or more battery packs 120. In some examples, the target temperature range is different for different phases of the charging event and/or for different current levels.

In some examples, the cooling conditions are actively adjusted during the different phases of the charging event so that battery-pack temperature is coordinated with charge-phase control. For example, during the ramp-up phase, coolant flow and thermal-box operation may be controlled to prepare one or more battery packs 120 for higher current delivery. During the sustained charging phase, coolant flow, radiator operation, and/or other thermal-management settings may be adjusted to maintain substantially stable battery-pack temperature while supporting a desired current or power level. During the taper phase, the cooling conditions may again be adjusted to account for reduced current, reduced heat generation, changing battery-pack voltage, and/or a target end-of-charge condition. In some examples, the control base 195 and/or the charging vehicle controller 150 modify one or more of the charging phases and one or more cooling conditions in response to changing route needs, battery-pack temperatures, connector temperatures, charging priorities, reserve-energy targets, and/or predicted thermal behavior of the battery packs 120.

Once the desired amount of energy is transferred, method 300 proceeds with (block 380) disconnecting the one mobile charging electric vehicle 192 from the one standard electric vehicle 194. In some examples, the desired amount of energy is determined based on one or more of a current SOC of the mobile charging electric vehicle 192, a current SOC of the standard electric vehicle 194, a target SOC of the standard electric vehicle 194, a minimum reserve SOC of the mobile charging electric vehicle 192, a predicted remaining route energy demand, an available charging time window, a charging efficiency value, a thermal condition, a connector or cable limit, a fault condition, and/or a fleet-level dispatch objective.

In some examples, the charging event is not intended to fully charge the standard electric vehicle 194. Rather, the charging event may transfer a selected amount of energy sufficient to enable the standard electric vehicle 194 to complete a delivery, service call, route segment, return-to-base trip, trip to a stationary charging location, reassigned route, or other mission objective while preserving a reserve SOC for the mobile charging electric vehicle 192. In further examples, the charging event is terminated based on a predicted improvement in fleet efficiency, route completion probability, or service-level compliance rather than a target full-charge level of the standard electric vehicle 194.

In some examples, a charging request may be fulfilled by more than one mobile charging electric vehicle 192 in sequence. For example, a first mobile charging electric vehicle 192 may deliver a first amount of energy to the standard electric vehicle 194, after which a second mobile charging electric vehicle 192 may complete or continue the charging event. Such sequential fulfillment may be used when route commitments, reserve-SOC constraints, traffic conditions, or projected fleet demand make it undesirable for a single mobile charging electric vehicle 192 to remain assigned to the charging request for the full duration of the charging event.

In some examples, method 300 further comprises (a) establishing priority charging zones within the operating area 199 based on historical demand patterns and/or forecasted demand patterns and (b) pre-positioning at least one mobile charging electric vehicle 192 in each of the priority charging zones during high-demand periods. This pre-positioning operation may involve calculating a combined reserve SOC level for each priority charging zone based on: (i) the number of standard electric vehicles 194 in each of the priority charging zones, (ii) the remaining energy demand for each of the standard electric vehicles 194 based on a planned route, and/or (iii) an expected arrival rate of charging needs for the zone. For example, the historical or forecasted demand patterns may correspond to time-of-day, day-of-week, seasonal, weather-related, route-specific, depot-specific, event-specific, customer-specific, and/or traffic-related charging demand patterns.

Method 300 may further comprise prioritizing the charging request based on the location and the SOC of the standard electric vehicle 194 associated with the charging request. For example, prioritization may be based on one or more of route criticality, time-to-depletion, inability to reach a charging base 197, expected effect on fleet service levels, customer priority, delivery deadline, service window, battery temperature, safety condition, and/or availability of alternative charging resources. Multiple charging requests may be ranked relative to one another so that limited mobile charging resources are allocated according to a fleet-level priority policy.

In some examples, the EV fleet 190 includes multiple simultaneous charging requests from different standard electric vehicles 194. The control base 195 may therefore maintain a queue of pending, active, and completed charging requests and may dynamically rank the charging requests based on one or more priority policies. For example, the priority policies may account for route urgency, predicted time-to-depletion, customer priority, projected service delay, expected energy needed, travel time of candidate mobile charging electric vehicles 192, and/or predicted impact on overall fleet performance.

Method 300 may further comprise calculating real-time energy budgets for sub-regions of the operating area 199 based on: (i) current SOC distribution across all vehicles, (ii) predicted energy consumption for active service routes, (iii) expected charging demand, (iv) available energy within the mobile charging EV sub-fleet 191, and/or (v) access to stationary charging infrastructure. For example, the real-time energy budgets may be used to modify charger selection, charging duration, partial-charge targets, vehicle reassignment, route planning, pre-positioning, and/or fleet reconfiguration.

In some examples, method 300 further comprises balancing energy among vehicles in the mobile charging EV sub-fleet 191 by charging one mobile charging electric vehicle 192 using another mobile charging electric vehicle 192. For example, the control base 195 may select a first mobile charging electric vehicle 192 having excess available energy and a second mobile charging electric vehicle 192 having a lower SOC, a higher forecasted charging demand, a more favorable location within the operating area 199, or a next-assigned response obligation. The selected vehicles may be positioned next to each other, a DCFC connection may be formed between the selected vehicles, and electrical energy may be transferred from the first mobile charging electric vehicle 192 to the second mobile charging electric vehicle 192 to rebalance fleet reserves before one or more subsequent charging events involving the standard EV sub-fleet 193. In some examples, such rebalancing is performed proactively before depletion occurs and/or in response to predicted demand imbalances among different portions of the operating area 199.

In some examples, the control base 195 balances available mobile charging resources among different portions of the operating area 199 by moving one or more mobile charging electric vehicles 192 from a first zone having excess projected reserve energy to a second zone having insufficient projected reserve energy. Such balancing may be performed before a charging request is received for the second zone, for example, based on forecasted charging demand, route density, traffic conditions, weather conditions, and/or expected availability of stationary charging infrastructure within the second zone.

In some examples, after completion of a charging event, the control base 195 stores event data associated with the charging event. Such event data may include vehicle identifiers, arrival times, wait times, energy transferred, charging duration, route outcomes, charging efficiency, battery-temperature information, and deviations from planned charging behavior. In further examples, the stored event data is used to update one or more charging-demand forecasts, route-energy predictions, priority policies, charger-selection models, and/or reserve-energy rules used in later iterations of method 300.

In some examples, method 300 further comprises reconfiguring the EV fleet 190 by transferring one or more electric vehicles between the mobile charging EV sub-fleet 191 and the standard EV sub-fleet 193. For example, such a transfer comprises changing the assigned operational role of an electric vehicle 100 without immediately changing hardware. In other examples, such a transfer comprises hardware conversion of the electric vehicle 100 from a standard electric vehicle 194 configuration to a mobile charging electric vehicle 192 configuration, or vice versa.

In some examples, method 300 further comprises reconfiguring the EV fleet 190 by changing the number of battery packs on one or more electric vehicles of the mobile charging EV sub-fleet 191 and/or the standard EV sub-fleet 193. For example, reconfiguring the EV fleet 190 may be performed responsive to one or more fleet-level conditions, such as a change in projected charging demand, a change in route density within one or more portions of the operating area 199, seasonal demand variation, a temporary loss of stationary charging infrastructure, vehicle maintenance status, a target ratio between the mobile charging EV sub-fleet 191 and the standard EV sub-fleet 193, cost objectives, expected service delays, and/or reserve-energy policies. In some examples, reconfiguration comprises determining, at the control base 195, that a selected electric vehicle 100 should be converted from the standard electric vehicle 194 configuration to the mobile charging electric vehicle 192 configuration, or vice versa, based on projected fleet performance metrics. In some examples, the projected fleet performance metrics comprise one or more of route completion rate, charging response time, total miles driven, total charging-base visits, service-level compliance, energy utilization, charging-asset utilization, and/or predicted unmet charging demand.

In some examples, reconfiguration of the EV fleet 190 is performed immediately upon determining that fleet composition should change. In other examples, reconfiguration is scheduled for a later time, such as during a depot visit, a maintenance interval, an off-shift period, a charging stop, or another opportunity that reduces operational disruption. In some examples, the control base 195 generates a reconfiguration plan identifying which electric vehicles 100 are to be reassigned, which electric vehicles 100 are to be physically converted, and one or more projected effects of the reconfiguration plan on fleet performance.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A method of operating an EV fleet comprising a mobile charging EV sub-fleet and a standard EV sub-fleet, the method comprising:
deploying the EV fleet in an operating area;
receiving location and state of charge (SOC) from each mobile charging electric vehicle in the mobile charging EV sub-fleet and each standard electric vehicle in the standard EV sub-fleet;
receiving, at a control base, a charging request from one standard electric vehicle in the standard EV sub-fleet;
selecting, at the control base, one mobile charging electric vehicle from the mobile charging EV sub-fleet;
positioning the one mobile charging electric vehicle and the one standard electric vehicle next to each other;
forming a direct current fast charging (DCFC) connection between the one mobile charging electric vehicle and the one standard electric vehicle, positioned next to each other;
transmitting electrical energy from the one mobile charging electric vehicle to the one standard electric vehicle using the DCFC connection;
disconnecting the one mobile charging electric vehicle from the one standard electric vehicle.

2. The method of claim 1, wherein the charging request is generated by the one standard electric vehicle and transmitted to the control base.

3. The method of claim 1, wherein the charging request is generated at the control base based on the location and the SOC of the one standard electric vehicle.

4. The method of claim 3, wherein the charging request is further generated at the control base based on a planned route for the standard electric vehicle.

5. The method of claim 1, wherein transmitting the electrical energy from the one mobile charging electric vehicle to the one standard electric vehicle further comprises circulating a cooling liquid through at least a DC-DC converter of the one mobile charging electric vehicle.

6. The method of claim 1, further comprising:
establishing priority charging zones within the operating area based on historical demand patterns; and
pre-positioning at least one mobile charging electric vehicle in each of the priority charging zones during high-demand periods in the historical demand patterns.

7. The method of claim 6, wherein pre-positioning comprises calculating a combined reserve SOC level for each priority charging zone based on:
(i) a number of the standard electric vehicles in each of the priority charging zones, and
(ii) a remaining energy demand for each of the standard electric vehicles based on a planned route.

8. The method of claim 1, further comprising prioritizing the charging request based on the location and the SOC of the standard electric vehicle associated with the charging request.

9. The method of claim 1, further comprising calculating real-time energy budgets for sub-regions of the operating area based on:
(i) current SOC distribution across all vehicles, and
(ii) predicted energy consumption for active service routes.

10. The method of claim 1, further comprising reconfiguring the EV fleet by transferring one or more electric vehicles between the mobile charging EV sub-fleet and the standard EV sub-fleet.

11. The method of claim 1, further comprising reconfiguring the EV fleet by changing a number of battery packs on one or more electric vehicles of the mobile charging EV sub-fleet and/or the standard EV sub-fleet.

12. The method of claim 1, wherein each mobile charging electric vehicle in the mobile charging EV sub-fleet and each standard electric vehicle in the standard EV sub-fleet is one of a box truck, a tow truck, a dump truck, a utility/service truck, a refrigerated truck, an ambulance/emergency vehicle, a recreation vehicle (RV), or a shuttle bus/passenger van.

13. The method of claim 1, wherein each mobile charging electric vehicle in the mobile charging EV sub-fleet and each standard electric vehicle in the standard EV sub-fleet is one of a Class 2 truck, a Class 3 truck, a Class 4 truck, and a Class 5 truck.

14. The method of claim 1, wherein each mobile charging electric vehicle in the mobile charging EV and each standard electric vehicle in the standard EV sub-fleet are same types of vehicle.

15. The method of claim 1, further comprising:
selecting, at the control base, a second mobile charging electric vehicle and a third mobile charging electric vehicle from the mobile charging EV sub-fleet;
positioning the second mobile charging electric vehicle and the third mobile charging vehicle next to each other;
forming a second direct current fast charging (DCFC) connection between the second mobile charging electric vehicle and the third mobile charging vehicle, positioned next to each other;
transmitting electrical energy from the second mobile charging electric vehicle to the third mobile charging vehicle using the second DCFC connection;
disconnecting the second charging electric vehicle from the third mobile charging vehicle.

16. The method of claim 15, wherein at least one mobile charging vehicle in the mobile charging EV sub-fleet comprises a bidirectional DC-DC converter for charging the at least one mobile charging vehicle using another mobile charging electric vehicle.

17. The method of claim 1, wherein each mobile charging electric vehicle in the mobile charging EV sub-fleet comprises:
a frame;
a base set of battery packs supported on the frame;
a DC-DC converter connected to the base set of battery packs and comprising a charging port for forming a direct current fast charging (DCFC) connection with the standard electric vehicle;
a power electronic unit connected to at least the base set of battery packs; and
an electric drive unit connected to the power electronic unit and configured to propel the mobile charging electric vehicle.

18. The method of claim 17, wherein each mobile charging electric vehicle in the mobile charging EV sub-fleet further comprises a liquid cooling system fluidically coupled to and configured to control temperature of the base set of battery packs.

19. The method of claim 17, wherein:
the frame comprises side rails and cross-members,
the side rails extend parallel to each other along a length of the mobile charging electric vehicle,
the cross-members extend substantially perpendicular to the side rails, and
at least one of the base set of battery packs is supported on the cross-members.

20. The method of claim 19, wherein at least one of the base set of battery packs is positioned between the side rails.
